(19) United States
(12) Patent Application Publication
(10) Pub. No.: US 2006/0107850 A1
(43) Pub. Date: May 25, 2006

(54) Stencil tape

(75) Inventors: Dana Rinaldi, Weymouth, MA (US); Jerry M. Serra, Chelmsford, MA (US); Chris Graff, Scituate, MA (US)

Correspondence Address: TYCO PLASTICS AND ADHESIVES, 7 ROSZEL ROAD, PRINCETON, NJ, 08550, US

(73) Assignee: Tyco Adhesives LP, Franklin, MA (US)

(21) Appl. No.: 11/240,184

(22) Filed: Sep. 30, 2005

Related U.S. Application Data
(60) Provisional application No. 60/615,503, filed on Oct. 1, 2004.

(51) Int. Cl. B05C 17/06

(52) U.S. Cl. 101/127

(57) ABSTRACT

A self-adhesive stencil tape having a backing layer and a residue-less adhesive applied thereon. The tape has cut-away portions of the backing layer forming a repeatable pattern for continuous application on a surface.

### BACKGROUND OF THE INVENTION

The present invention relates to an adhesive tape for applying a decorative pattern or design to a particular surface.

Stencils may consist of separate portions of a design configuration on a die cut plastic sheet or other semi rigid backing held in place with masking tape or spray adhesive, used for applying a particular design to a surface. If an adhesive is not applied to the stencil, the stencil must be held in position manually so that paint can be applied. However, these stencils provide a limited length of a pattern. If a repeating pattern is desired, individual sections of an existing pattern must be reapplied and realigned to an existing pattern. In other words, a user that desires to apply a design pattern, for example, along the border of an interior room must reapply a stencil along the border repeatedly.

Existing stencils usually only provide a limited length (e.g. 2-3 feet), thereby forcing a user to realign each section of the pattern to complete the border. A drawback associated with these devices, is that with intricate designs it is difficult to align each section of a pattern accurately enough such that the design appears repetitive and continuous. Another drawback with existing stencils is that when paint is applied between stencil sections, a line appears at the joint area between the sections. Accordingly, there is a need for an improved stencil configured for repeatability of a particular design in a self-adhesive roll to accommodate proper alignment on an application surface to reduce labor and provide ease of use.

### BRIEF DESCRIPTION OF THE DRAWINGS

FIG. 1 is a perspective view of a stencil tape in accordance with one embodiment of the present invention.

FIG. 2 illustrates a cross sectional view of the stencil tape 10 along edge 15 in accordance with one embodiment of the present invention.

### DETAILED DESCRIPTION OF THE PREFERRED EMBODIMENTS

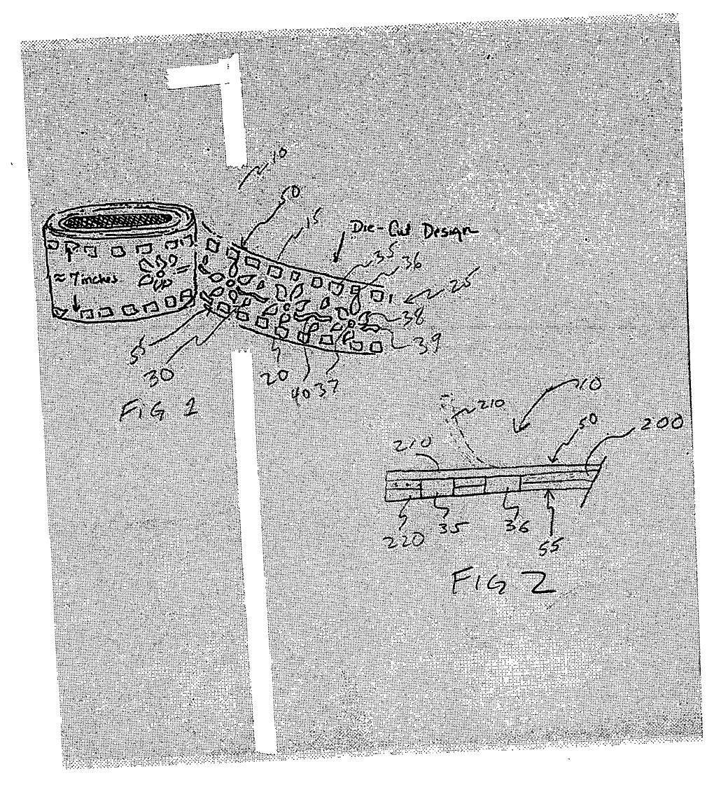

Referring now to the drawings in which like numerals are used to indicate the same or similar elements, FIG. 1 illustrates a perspective view of stencil tape 10 in roll form. Tape 10 includes a first longitudinal edge 15 and a second longitudinal edge 20, each running the length of tape 10 from a first end 25. A decorative pattern 30 is illustrated, by way of example, as a repeatable flower design. The selected design pattern repeats throughout the length of tape 10. The width of tape 10, the distance between edge 15 and edge 20 is adaptable to the size of a border or stencil to be applied to a particular surface. Similarly, because the tape is in roll form using a pressure sensitive adhesive, various lengths may be employed simply by tearing or cutting tape 10.

Pattern 30 may include a plurality of cut out portions 35-40 that comprise a particular pattern or design. Each cut-out portion comprises a removed area of adhesive and flexible backing portion as described below. The cut-out portions 35-40 expose the top surface 55 to application of paint or other finishing material and the combination of the cut-out portions provide the pattern or design.

A pattern or design is repeatable and continuous within tape roll 10. The tape roll may correspond to typical room sizes such as, for example, 12′×9′, 12′×12′, etc. with a certain percentage of additional tape to accommodate for mistakes and/or scrap during the application process. This provides for easy transition at wall corners, door or window jams, etc. in that, for example, the tape pattern continues around a corner avoiding the requirement of cutting or tearing tape 10 and realigning the design pattern for continuation on an adjacent wall or opposite side of a wall or door jam. In this manner, the stencil tape in accordance with an embodiment of the present invention allows for a repeatable and continuous pattern or design to be applied to a wall or other surface.

FIG. 2 illustrates a cross sectional view of the stencil tape 10 along edge 15 which includes a flexible backing layer 220, pressure sensitive adhesive layer 200, and release liner layer 210. Backing layer 220 may be comprised of polymer films, non-wovens, etc. Cut-out portions 35 and 36 are shown by way of example to illustrate that the adhesive layer 200 and flexible backing layer 220 are removed to correspond to a particular design configuration. Release liner 210 may be comprised of paper or film material that adheres to adhesive layer 200 at bottom surface 50, but when removed, is configured to avoid stripping adhesive away from backing layer 220. In addition, release layer 210 is contiguous with cut-out portions 35 and 36, however layer 210 does not have cut-out portions corresponding to 35 and 36 thereby providing ease of application of tape 10 to an application surface. Adhesive layer 200 is a pressure sensitive residue-less natural or synthetic adhesive such as natural rubber or acrylic that forms a temporary bond between the surface and the flexible backing layer 220. The adhesive is residue-less so that once the stencil tape is removed from the surface after painting, adhesive residue does not remain on the surface to compromise surface finishing around the design or pattern. Once tape 10 is positioned on a surface, paint, varnish or other finishing application is applied over the tape. Once this finishing application is sufficiently dry, tape 10 is removed and the stencil design remains on the wall or surface.

It is important to note that to those skilled in the art, changes could be made to the embodiments described herein without departing from the scope of the invention. It should be understood that this invention is not limited to the particular embodiments disclosed, but is intended to cover all modifications which are within the scope and spirit of the invention as defined in the appended claims.

What is claimed is:

1. A stencil tape having a predetermined length comprising:
a flexible backing layer;
an adhesive layer applied to a first surface of said flexible backing layer; and
a pattern comprising cut away portions of said backing layer and said adhesive layer, said pattern repeating continuously along the entire length of said stencil tape.

2. The stencil tape in accordance with claim 1 wherein said adhesive is a pressure sensitive adhesive.

3. The stencil tape in accordance with claim 1 further comprising a release liner covering said adhesive layer.

4. The stencil tape in accordance with claim 2 wherein said pressure sensitive adhesive is residue less.

5. The stencil tape in accordance with claim 1 wherein said release liner covers said cut away portions of said backing layer.

6. The stencil tape in accordance with claim 1 wherein said backing layer has a first edge, said pattern comprising cut-away portions of said first edge of said backing layer.

7. The stencil tape in accordance with claim 6 wherein said backing layer has a second edge, said pattern comprising cut-away portions of said second edge of said backing layer.

8. The stencil tape in accordance with claim 7 wherein said pattern comprising cut-away portions of said first and second edges of said backing layer.

9. The stencil tape in accordance with claim 3 wherein said stencil tape is in a roll form such that said release liner is contiguous with said backing layer.

10. The stencil tape in accordance with claim 1 wherein said backing layer is a polymer film.

11. The stencil tape in accordance with claim 3 wherein said release liner is a paper material.

12. The stencil tape in accordance with claim 1 wherein said adhesive layer is a natural rubber based adhesive.

13. The stencil tape in accordance with claim 1 wherein said adhesive layer is an acrylic based adhesive.

14. A method of applying a decorative pattern to a surface comprising:
positioning a stencil tape on an application surface, said stencil tape comprising a flexible backing layer, a removable liner layer and an adhesive layer applied to a first surface of said flexible backing layer and positioned between said backing layer and said liner layer, and a pattern comprising cut away portions of said backing layer and said adhesive layer, said pattern repeating along the entire length of said stencil tape;
removing said liner layer once said stencil tape is in a desired position;
applying pressure to said stencil tape such that said adhesive adheres to said surface;
applying paint or other covering over said stencil tape and on said surface; and
removing said stencil tape from said surface after the paint or other covering has sufficiently dried.

15. The method in accordance with claim 14 wherein the step of positioning said stencil tape further comprises aligning said repeatable pattern on said surface such that said tape is applied continuously along said surface.
